(19) United States
(12) Patent Application Publication
(10) Pub. No.: US 2023/0093957 A1
(43) Pub. Date: Mar. 30, 2023

(54) INSTRUMENT TO BYPASS FRACTURED FRAGMENTS OF ENDODONTIC ROTARY FILE IN ROOT CANAL OF A TOOTH

(71) Applicants: Dana YOUSIF AL RAEESI, Sharjah, Dubai (AE); Rashid MOHD EL ABED, Dubai (AE); Sireen ALRAESSI, Sharjah (AE); Zuhair ALKHATIB, Dubai (AE)

(72) Inventors: Dana YOUSIF AL RAEESI, Sharjah, Dubai (AE); Rashid MOHD EL ABED, Dubai (AE); Sireen ALRAESSI, Sharjah (AE); Zuhair ALKHATIB, Dubai (AE)

(21) Appl. No.: 17/911,361

(22) PCT Filed: Mar. 20, 2020
(86) PCT No.: PCT/IB2020/052608

§ 371 Date: Sep. 13, 2022

(51) Int. Cl. A61C 5/42

(52) U.S. Cl. CPC A61C 5/42

(57) ABSTRACT

Instruments to bypass fragments of fractured endodontic rotary files are configured for bypassing fractured fragments of endodontic rotary files that have become lodged within a root canal of a tooth during a root canal treatment. An instrument can be an endodontic file having a handle and a working shaft. The active distal portion of which includes a flat, therefore inactive, lateral surface 3. The files have a dual design along the active distal portion with a safe side and a cutting side to ease the penetration of the instrument in the narrow space between the root canal wall and the broken fragment of a NiTi endodontic rotary file.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to procedures/operations that employ endodontic instruments in preparing a root canal of a tooth for receiving a sealer and/or filer material. More particularly, the invention relates to instruments and methods for removing a portion of an endodontic instrument that has broken off from the mains shaft and remained lodged within the root canal being prepared.

### 2. Description of Related Art Including Information Disclosed Under 37 CFR 1.97 and 37 CFR 1.98

When a root canal of a living tooth becomes infected or abscessed, discomfort and in many cases, severe pain can result. In the early days of dentistry, the only solution was to pull the tooth. More recently, however, dental practitioners have learned to successfully remove the pulp material that forms the nerve of the tooth which has become infected. After careful preparation of the canal that contained the nerve material, the canal is refilled with an inert filling material, such as gutta-percha. This process allows the patient to keep his tooth.

There is a great variety of file choices classified according to various parameters, going from different metals to flute configurations and geometries, tapers, lengths, and handle designs. They all can be used during cleaning and shaping of root canals. Currently preferred materials of construction include stainless steel and Super elastic alloys e.g., some nickel-titanium (Ni—Ti) alloys. Although such instruments generally exhibit good flexibility, resilience and strength, they can sometimes fail during use within a root canal of a tooth, resulting for instance in a broken fragment becoming tightly lodged within the root canal of a tooth.

The consequences of leaving broken instrument fragments within the root canal can be serious. In some cases, leaving the broken instrument in the tooth can result in later complications that require extraction of the tooth. Because of this, it is generally preferred that the broken part be removed from the root canal, if possible, to prevent additional future problems. Nevertheless, it has generally proven very difficult to remove broken instrument fragments. In particular, rotary endodontic files used during canal preparation often break after becoming wedged inside the structure of the root. Therefore, the very fact that the instrument broke generally indicates that the instrument became stuck in the tooth structure and can therefore not be easily pulled free. In addition, the instrument often breaks at a point deep within the canal, not easily visible or accessible to the practitioner.

The alternative option is to bypass the fractured endodontic rotary files to reach the full working length of root canal in order to complete root canal treatment through completing the process of cleaning, shaping and filling the root canal space.

Traditionally, small files were used in efforts to bypass fractured instruments. Until now, there has been a lack of simple, efficient, and effective means for bypassing fractured fragments of endodontic rotary files. Therefore, what is needed is specially designed instruments to manage the clinical case present with fractured endodontic rotary files.

### BRIEF SUMMARY OF THE INVENTION

The proposed instruments share similarity with manual standard stainless-steel K-type files, adding however additional features in terms of file designs and manufacturing processes. The instruments according to the invention are manufactured in compliance with ISO standards.

In order to solve the above mentioned problem, i.e. to remove from a root canal of a tooth a part of a broken endodontic file retained in said root canal, a complication which may possibly occur during root canal treatment, the instrument of the invention is mainly characterized in that it consists of an endodontic file having a working shaft having an active cutting length, the active distal portion of which includes a flat, therefore inactive, lateral surface.

The proposed instrument is as mentioned designed to bypass fractured for example NiTi endodontic rotary files and is therefore employed during root canal treatment. It helps perform a complete root canal treatment despite the problem which occurred, eliminating the risk of leaving debris or microorganisms within the root canal system. Because of the flat surface at the end of the free end of the shaft, it facilitates easy bypass of fractured endodontic rotary files within root canals so that it does not compromise the prognosis of the treatment, at a later point of time.

Preferably, according to the invention, the inactive flat lateral surface has an inclination of 2 0 with respect to the main axis of the file.

More preferably, the said inactive flat lateral surface extends over a length of at least 3 mm.

In fact, in a possible embodiment of the invention, the active length has a double tapered profile, the conicity being greater on the distal portion comprising the inactive flat lateral surface than on the rest of the active length.

In the usual daily practice, in general, two instruments according to the invention might be sufficient for the practitioner. A first instrument may have a diameter of 0.10 mm, the conicity of the active distal portion comprising the inactive flat lateral surface being 4%, while the conicity of the rest of the active length is 2%.

As second possible size of instrument, the endodontic file may be 0.15 mm in diameter, with a conicity of the active distal portion comprising the inactive flat lateral surface of 3% while that the conicity of the rest of the active length is 2%.

Also, according to the invention, the distal portion preferably ends with a tip in the form of an eccentric pyramid. The specific design of the cutting tip has in other words a off-center pyramid shape. The tip of the pyramid is pointed toward the flat (smooth) surface of the file, meaning that the top of the pyramid is located between the axis of the working shaft 1 and the flat lateral surface 3.

Preferably, on the shaft of the file, between the active cutting length and the handle, there can be a groove marking the location and presence of the flat lateral surface.

The invention also relates to a kit of instruments for the removal, from a root canal, of a part of broken endodontic tool retained in said root canal, characterized in that it comprises at least two instruments as described before having various dimensions, possibly the sizes mentioned above, and intended to be used successively.

As emphasized above, a possible way of using the endodontic instrument of the invention, particularly advantageous for the practitioners in their daily practice, is to keep two files handy, having two different sizes, firstly two different diameters. Also, the proposed total length of both the instruments will then be respectively 17 mm et 22 mm, including a working part of about 16 mm.

As may be inferred from the above-mentioned context and features, the main objective of the present invention is to provide an instrument which generally speaking enables root canal treatment and that is especially suited to by-pass a separated/fractured portion of an endodontic rotary file in the root canal of teeth.

It is a further objective of the present invention to provide an instrument that is especially suited for the smooth entry of the tool into the narrow root canal space, to be capable of being squeezed smoothly between the root canal wall and the separated/fractured portion of the endodontic rotary file.

Furthermore, it is an objective of the present invention to provide an instrument which enables the easy by-passing of the separated/fractured portion of the endodontic rotary file reaching to the full working length of a root canal.

In addition, it is an objective of the present invention to provide a glide path entry for manual or rotary endodontic files after by-passing separated/fractured fragments or portions of endodontic rotary files.

Yet another objective of the present invention is to provide a dental instrument which has specific dimensions adaptable to fit between the root canal wall and the separated/fractured portion of the endodontic rotary file.

Yet another objective of the present invention is to offer an instrument whose working area (flat lateral side design) can be controlled to a specific size, which is adapted to the limited space between the root canal wall and the separated/fractured portion of the endodontic rotary file.

Yet another objective of the present invention is to provide a dental instrument, which assists in completion of root canal treatment, through cleaning and shaping the entire length of the root canal. The implicit goal is also that no uncleaned areas remain in the canal, where microorganisms could possibly survive, jeopardizing the prognosis of treatment.

Yet another objective of the present invention is to provide an instrument, which enables a better prognosis of root canal treatments of teeth.

Yet another objective of the present invention is to provide an instrument, which causes the root canal treatment to become more cost-effective than the conventionally deployed solutions, including obviously tooth extractions.

### BRIEF DESCRIPTION OF THE SEVERAL VIEWS OF THE DRAWINGS

The detailed description, in conjunction with the accompanying drawings, provides a clear understanding of the invention. Persons skilled in the art will however appreciate that the hereinafter drawings only depict a possible embodiment of the invention. The invention is therefore not limited to the depicted example, and variations and/or combinations of the concepts and features of the invention disclosed hereinafter are also to be treated as a part of the present invention and disclosure.

FIG. 1 shows front and side elevation views of an instrument (file) to bypass fractured endodontic rotary file according to the invention.

FIG. 2 is a side elevation view of the handle of an instrument of the present invention.

FIG. 3 depicts a perspective view of such an instrument, including an enlarged perspective view of the active distal portion of the file.

FIG. 4 shows elevation views of the active length of the instrument.

FIG. 5 is a side elevation view of the active distal portion of the same instrument.

FIG. 6 depicts some cross-sectional or side views in several locations along the working or active length of the file, i.e. more particularly:
Section A is a cross sectional view of the file at A in FIG. 4;
Section B is a cross sectional view of the file at B in FIG. 5;
Section C is a cross sectional view of the off-centered pyramid cutting tip, taken at C in FIG. 5; and
Section D is the side view of the off-center pyramid cutting tip;

FIG. 7 is a cross sectional view of the instrument of the invention used in a human tooth root canal, showing the end portion of the file squeezed between the canal wall and the instrument.

FIG. 8 is an enlarged cross sectional view of the instruments in a human tooth root canal showing better a 1 mm insertion (penetration) of the file tip between the canal wall and the fractured part of the endodontic rotary file.

### DETAILED DESCRIPTION OF THE INVENTION

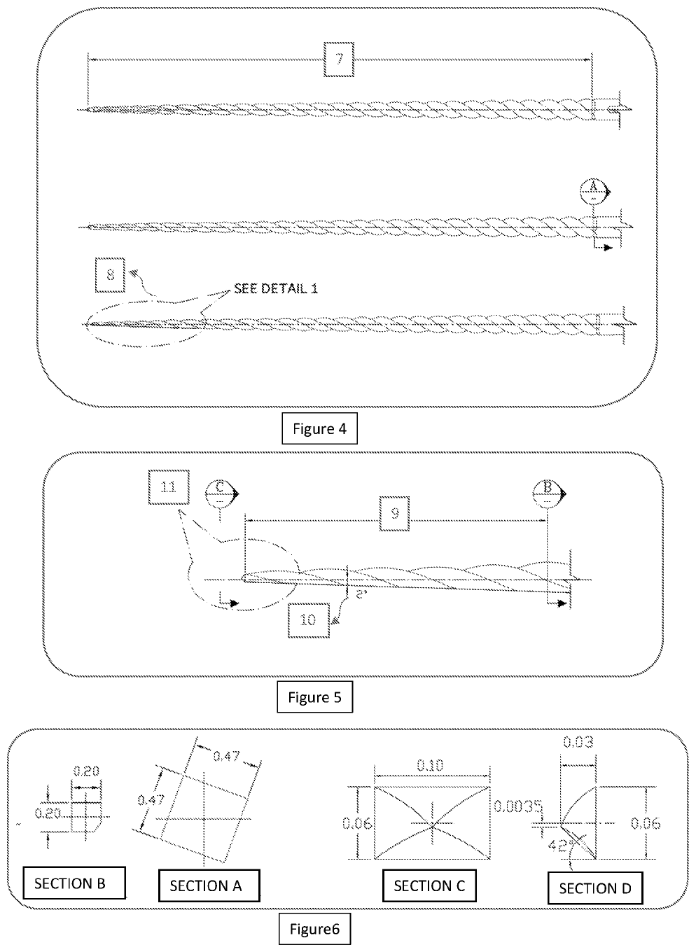

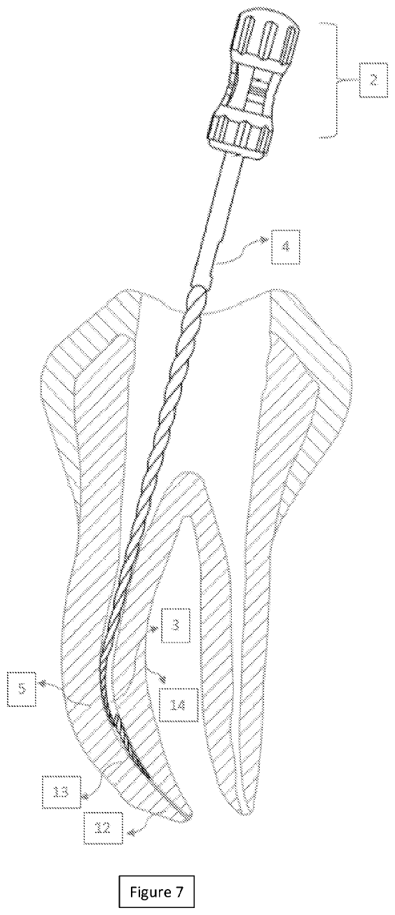

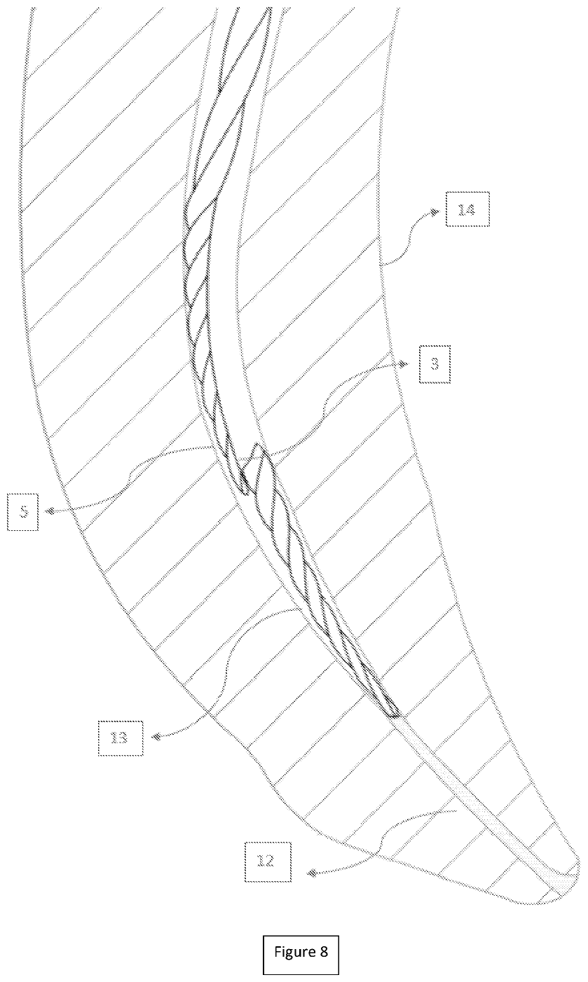

The instrument according to the invention, provided for bypassing a fractured part 13 of a endodontic rotary file, for example made of NiTi, as may for instance be seen in FIGS. 7 and 8, has a dual taper or conicity, of for example namely 4% in the first 3 mm and then 2% for the rest of the active length 7 (see FIG. 4), in one of the possible embodiments, i.e. the one having the shortest length.

In a second embodiment, the instrument according to the invention has a conicity of 3% for the first 3 mm and then of 2% for the rest of the active length 7 of the tool (see FIG. 4), this applying to the instruments having the longest length. In the first 3 mm of the distal portion 9 of the file 1 (see in FIG. 5), near the tip 11 of the instrument, a flat (smooth) surface 3 is also provided, having a two degrees (2°) inclination 10 (see in FIG. 5) with respect of the longitudinal axis of the tool.

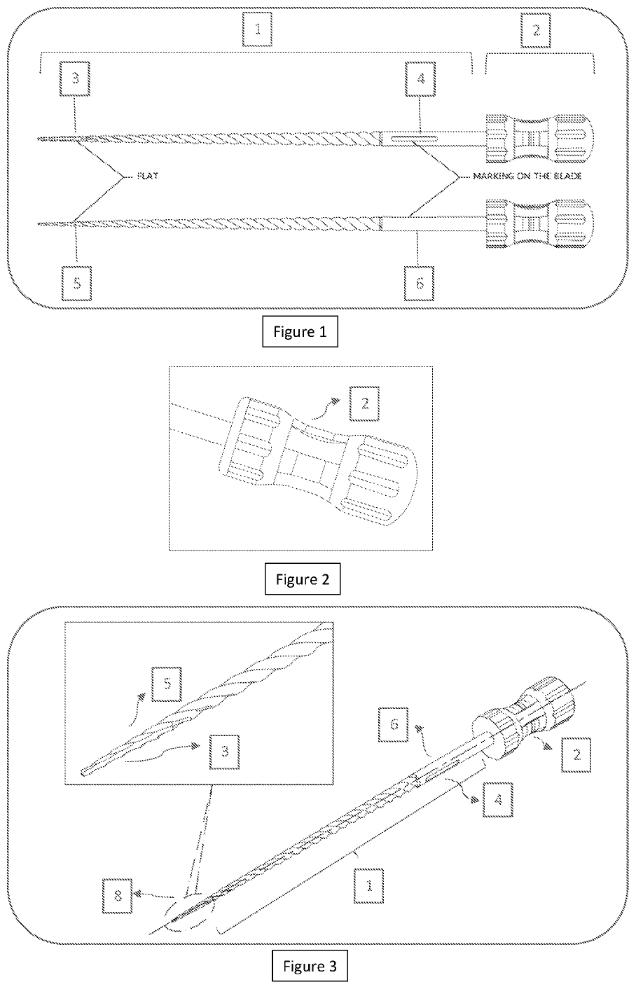

The instrument basically includes a handle 2 and a tool or working part 1 (see for instance in FIGS. 1 to 3). The tool part 1 (excluding the handle 2) includes an distal end portion 9 (see FIG. 5) provided with the flat surface 3, which is actually part of the more general active/cutting length 7. A perspective view of the distal end portion of the instrument is actually shown in the enlarged view depicted in FIG. 3, this enlarged view being referred to as 8 in FIG. 3 as well as in FIG. 4.

Forming together the working part 1 of the instrument of the invention, in the continuation of the portion 7 and located between the internal end of it and the handle 2, is a cylindrical linking member provided with a groove 4, whose function is to mark the side of the working part where the flat surface 3 is situated. The opposite surface 6 of the said cylindrical portion is by contrast not provided with any kind of marking member.

The dual taper or conicity makes the file 1 stiffer, which makes easier the penetration of the file 1 between the root canal and the separated/fractured part 13 of the for instance made of NiTi rotary file, as depicted in FIGS. 7 and 8.

The instrument of the present invention has in fact an off-center pyramid shaped tip 11 (see FIGS. 5 and 6), as depicted in sections C and D of FIG. 6, this ensuring a better guided penetration of the instrument with less chances of creating iatrogenic problems like ledges or perforations.

Because of the above mentioned dual design along the distal end portion 9, with the first 3 mm provided with a flat surface (smooth) 3 without flutes, it becomes possible to squeeze more easily the instrument of the invention between the root canal space and the separated/fractured part 13 of the NiTi endodontic rotary file (see FIGS. 7 and 8). The flat surface 3 may be in contact with the fractured part 13 while the opposite working side provided with a cutting surface 5 has flutes which allows the cutting of dentin. The cutting action furthermore creates space for further cleaning and shaping of the root canal space.

The depth of the flutes on the working cutting side 5 (see for instance in the enlarged portion referred to as 8 in FIGS. 3 and 4) of the active distal portion 9 is shorter than those of regular endodontic files, which allows for more efficiency in cutting the dentin, and creates subsequently space within the root canal system. The dual design of the file 1, including simultaneously a smooth-side and a cutting-side in the portion 9 of the file 1 near the tip 11, is a new feature designed especially to ease the penetration of the instrument in the narrow space between the root canal wall and the fractured part 13 of a NiTi endodontic rotary file.

The manufacturing method of instruments in accordance with the invention has been especially adapted to be suitable for the anatomical needs resulting from the narrow root canal space, in the presence of a separated part 13 of NiTi endodontic rotary files. The device is especially designed to handle cases where NiTi endodontic rotary files break during root canal treatment (when extraction of the broken part 13 is not possible), thus it does not jeopardize the prognosis of the treatment at a later point of time.

The present invention embodies:
a standard diameter at the tip 11 of the file 1,
dual taper in its working area, i.e. the active length 7,
a cutting edge 5 at the side of the active distal portion facing the root canal wall and a safe-side 3 (flat/smooth) facing the fractured part of the NiTi rotary endodontic file.

The goal of the newly invented instrument is to bypass broken/separated/fractured portions of NiTi endodontic rotary files in introducing an especially designed instrument that can complete the root canal treatment in an efficient way.

This invention is designed in consideration with the narrow root canal space due to the presence of a separated/fractured part of a NiTi rotary endodontic file. This instrument is designed to help the clinicians to perform complete root canal treatment without the risk of leaving uninstrumented/uncleaned root canal walls.

As an example of the way it can be utilized, the practitioner has first to determine the level and length of fractured portion of rotary NiTi file within the canal space in order to choose the appropriate instruments in term of file size, keeping in mind that he/she has to bypass the said broken portion.

FIGS. 7 and 8 illustrate a tooth having a root canal within which the fragment of an endodontic file 13 has been broken and become wedged within the root structure surrounding the root canal. As may be seen, the broken file fragment 13 may be located deep within the root canal of the tooth so that it cannot be easily visible or accessible to the practitioner using usual removal means, thus bypassing is the appropriate option.

Initially, a normal standard K-type file is inserted to determine the working length by testing the level of the separated portion of the rotary file with light apical pressure. Then the proposed invented file 1 is inserted making sure that the flat (smooth) surface 3 is facing the fragment 13 (using the groove 4 marking the suitable face) while the cutting surface 5 is adequately facing the dentinal wall. This dual feature is especially designed to ease the penetration of the instrument 1, in fact the active length 7 of it, in the narrow space between the root canal wall and the broken fragment 13 of the NiTi endodontic rotary file.

Furthermore, during the file 1 insertion between the said broken fragment 13 and canal wall the practitioner has to make sure to be away of the danger zone 14. The invented instruments are then used performing watch-winding hand motions. The winding motions are effected in a reciprocating way, going back and forth (clockwise/counterclockwise) when rotating the instrument.

A first light apical pressure is applied to move the file 1 deeper into the canal, reaching a further point between the fractured fragment 13 of the file and the canal wall, then watch-winding again, performing to this purpose the same action with hand motions at a level located 1 mm deeper.

This is followed by a withdrawal of the instrument, then the practitioner irrigates the root canal, resumes with a corresponding K-type file, and finally repeats the entire operation, resuming all the above mentioned steps 1 mm deeper than before until achieving the full working length of the root canal, including the remaining untouched portion 12 of the canal, i.e. the portion beyond the broken fragment 13 of the rotary file.

The invention is not limited to the depicted example, which shows only a possible example of instruments fulfilling the aim as set at the beginning of the specification.

1. An instrument for bypassing a part of a broken endodontic tool retained in a root canal, the instrument comprising:
an endodontic file having a working shaft having an active cutting length, the active distal portion of which includes a flat, therefore inactive, lateral surface.

2. The instrument, according to claim 1, wherein the inactive flat lateral surface has an inclination of 2° with respect to the main axis of the file.

3. The instrument, according to claim 1 wherein the inactive flat lateral surface extends over a length of at least 3 mm.

4. The instrument, according to claim 1, wherein the active length has a double tapered profile, the conicity being greater on the distal portion comprising the inactive flat lateral surface than on the rest of the active length.

5. The instrument, according to claim 1, wherein the distal portion ends with a tip in the form of an eccentric pyramid, the top of the pyramid being located between the axis of the working shaft and the flat lateral surface.

6. The instrument, according to claim 1, wherein the file has a diameter of 0.10 mm, and wherein the conicity of the active distal portion comprising the inactive flat lateral surface is 4%, while the conicity of the rest of the active length is 2%.

7. The instrument, according to claim 1, wherein the file is 0.15 mm in diameter, and that the conicity of the active distal portion comprising the inactive flat lateral surface is 3% while that the conicity of the rest of the active length is 2%.

8. A kit of instruments for the removal from a root canal of a part of broken endodontic tool retained in said root canal, the kit comprising: at least two instruments according to claim 1, having various dimensions and intended to be used successively.
